(19) United States
(12) Patent Application Publication
(10) Pub. No.: US 2004/0262893 A1
(43) Pub. Date: Dec. 30, 2004

(54) Pedestrian protection device for a vehicle

(76) Inventors: Peter C. Kempf, Dexter, MI (US); Barney Bauer, Shelby Township, MI (US); Kurt Schulz, Harper Woods, MI (US)

Correspondence Address: KEY SAFETY SYSTEMS, INC., PATENT DEPARTMENT, 5300 ALLEN K BREED HIGHWAY, LAKELAND, FL, 33811-1130, US

(21) Appl. No.: 10/602,860

(22) Filed: Jun. 25, 2003

(51) Int. Cl. B60R 21/34; B60R 21/22

(52) U.S. Cl. 280/730.1; 180/274

(57) ABSTRACT

An airbag module has an airbag inflator and an airbag. The airbag inflator inflates the airbag to form a frame with an opening. A support extends across the opening. The support may be a net.

### FIELD OF THE INVENTION

This invention relates to an airbag system that deploys external of a vehicle to protect a pedestrian.

### BACKGROUND OF THE INVENTION

Airbags are commonly used to protect the occupants of a vehicle. Recently, manufacturers have sought to employ airbags located external of a vehicle to protect pedestrians who are struck by the vehicle. Existing vehicle external airbag systems may deploy an airbag over a particular portion of the vehicle, such as a windshield or a front pillar of the vehicle. While such airbag devices may mitigate injury by cushioning the pedestrian's impact against a particular component, they do not prevent injury that may result from the pedestrian caroming off the vehicle onto the pavement. Existing airbag systems merely serve to cushion and deflect the pedestrian away from the vehicle.

In addition, existing vehicle external airbags may deploy over the windshield of the vehicle. Such an airbag, however, will block the view of the vehicle operator. It is desirable to provide an external airbag system that allows the vehicle operator to maintain as much viewing area through the windshield as possible.

There is a need for a vehicle external airbag system that prevents injury following the initial vehicle impact with a pedestrian without reducing vehicle operator visibility.

### SUMMARY OF THE INVENTION

The invention comprises an airbag module having an airbag inflatable by an airbag inflator. In contrast to existing vehicle external airbag systems, however, the inventive airbag module uses the airbag to form an inflatable frame to catch a pedestrian struck by the vehicle and to prevent the pedestrian from caroming off the vehicle. The frame has a support, such as a net, extending across an opening of the frame to secure the pedestrian. In this way, the external airbag secures the pedestrian to the vehicle in an accident.

In addition, the frame may have multiple inflatable components, such as a first member, a second member and a third member. The first member may be transverse to the second member while the second member may be transverse to the third member. The net may be supported by two of the three members.

The airbag may be stored in a housing. The housing may be located in an area forward of a vehicle hood. At this location, the airbag may be quickly deployed to catch a pedestrian in the event of a front end collision.

The airbag frame may have an opening large enough to permit a vehicle operator to continue to see the road. The net extending across the opening should not obscure the vehicle operator's view. The opening may be about the width of a vehicle windshield. In this way, the invention improves the driver's ability to control the vehicle following any collision.

The pedestrian protection device for a vehicle has inventive airbag module with a unique airbag. The airbag provides the inflatable support for a net that extends across an opening of the airbag. The opening is framed by a first inflatable member spaced from a second inflatable member. The net may extend across the opening and be supported by the first inflatable member and the second inflatable member. The net may be located between the two members. A third inflatable member may be transverse to the first inflatable member and the second inflatable member. Each of the inflatable members may be interconnected to allow a single inflator to inflate all three members simultaneously. The three inflatable members may form a U-shaped frame.

The pedestrian protection device deploys from a location forward of a vehicle hood. As the airbag inflates a net connected to the airbag extends across a hood portion of the vehicle. Preferably, the airbag extends generally perpendicular to the vehicle hood to provide a large surface for catching a pedestrian.

### BRIEF DESCRIPTION OF THE DRAWINGS

The various features and advantages of this invention will become apparent to those skilled in the art from the following detailed description of the currently preferred embodiment.

FIG. 1 is a perspective view of inventive airbag module showing the airbag in a fully deployed state.

FIG. 2 is a side view of airbag module with the airbag in the undeployed state.

FIG. 3 illustrates the deployment of airbag of FIGS. 1 and 2.

FIG. 4 is a side view of airbag in a fully deployed state.

FIG. 5 illustrates airbag catching a pedestrian.

### DETAILED DESCRIPTION OF THE INVENTION

As used herein and in the claims terms indicating locations such as “forward”, “rearward”, “top” and “bottom” are understood to refer to relative locations with respect to a motor vehicle that is sifting upright.

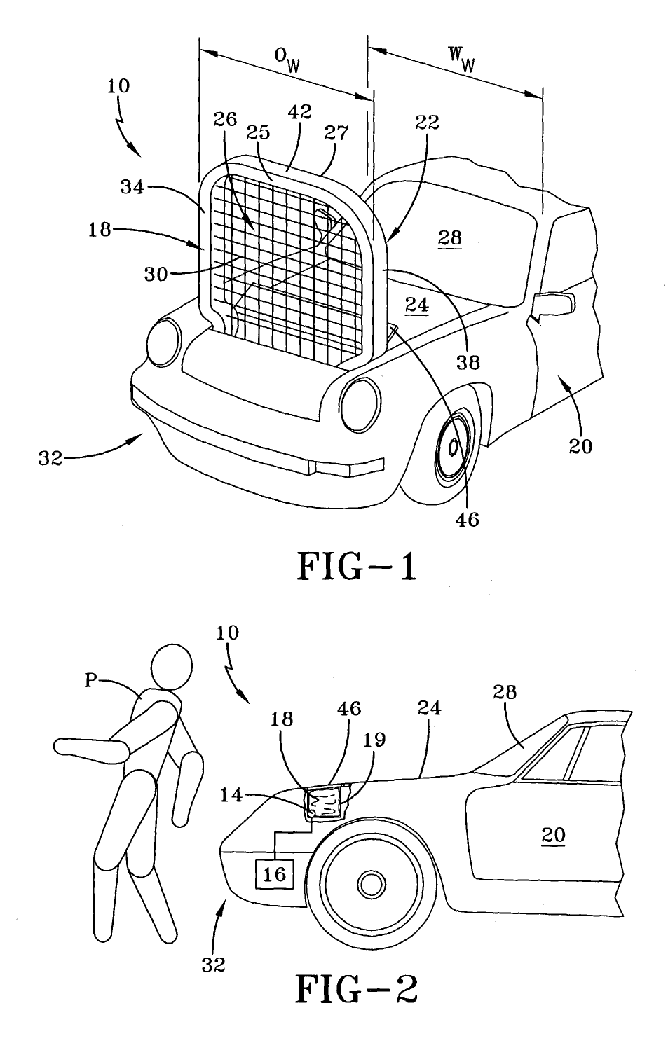

FIG. 1 is a perspective view of a vehicle 20 equipped with the inventive airbag module 10. In this figure, the pedestrian protection device 18 is fully deployed and inflated. The pedestrian protection device 18 comprises a frame 22 having a first inflatable member 34, a second inflatable member 38 and a third inflatable member 42 which act in concert to form a U-shaped frame 22. The first inflatable member 34, second inflatable member 38, and third inflatable member 42 may be connected to one another so as to permit inflation gas to pass through the first inflatable member 34, second inflatable member 38 and third inflatable member 42 from a single airbag inflator 14, that is best seen in FIG. 2.

The frame 22 defines an opening 26 having an opening width O_{W}. The opening width O_{W} is preferably about the same width as the width W_{W} of windshield 28. In this way, pedestrian protection device 18 permits a vehicle driver to see the road with relatively little obstruction.

In further contrast to existing external airbags, the pedestrian protection device 18 has a support 30, here a net, extending across the opening 26. As will be shown, the support 30 helps secure a pedestrian from caroming off vehicle 20 following impact. It is preferable that the support 30 be located at the front edge 25 of the frame 22 rather than rear edge 27.

FIG. 2 illustrates the airbag module 10 in an undeployed state. As shown, the airbag module 10 is located in a vehicle storage compartment 19, which also houses an inflator 14. The inflator 14 is controlled by an impact detection system 16. The impact detection system may employ any suitable impact detection technology, for example a magnetostrictive sensor or a pressure sensor. A door 46 is hinged to the vehicle storage compartment 19 and may open along the direction of arrow A. In the undeployed state, the door 46 remains closed allowing the door 46 to serve as an outer skin for vehicle 20. It should also be noted that the airbag module 10 is located in area 32 located forward of the vehicle hood 24 although other locations along the vehicle hood 24 may serve the same function.

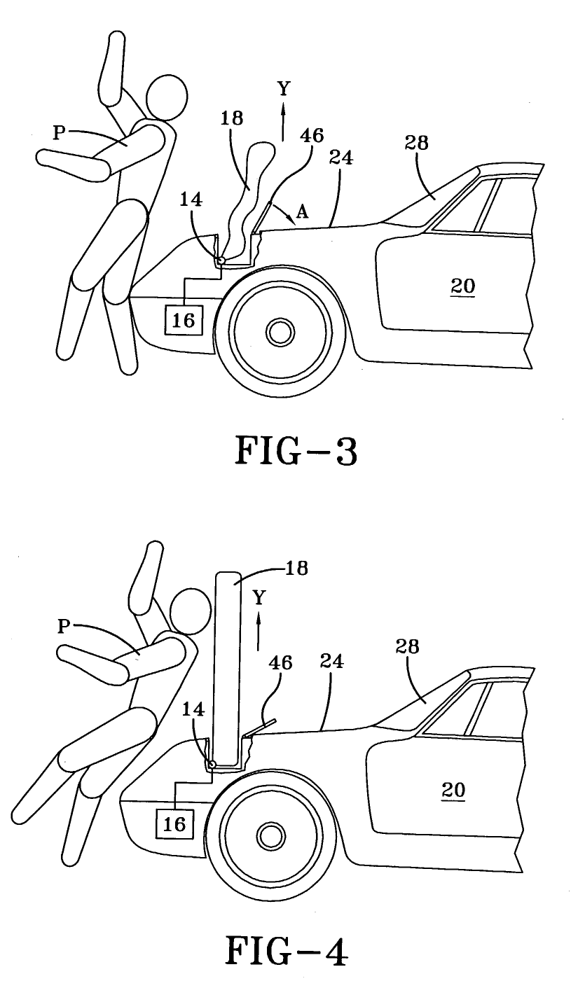

The impact detection system 16 may sense the impact of a pedestrian P relative to the vehicle 20. If the impact detection system 16 detects an impact with the pedestrian P, the impact detection system 16 instructs the inflator 14 to provide inflation gas to the pedestrian protection device 18. As shown in FIG. 3, the expansion of the pedestrian protection device 18 causes the door 46 to open in the direction of arrow A as the pedestrian protection device 18 deploys generally perpendicular to the vehicle hood 24 along the direction of arrow Y.

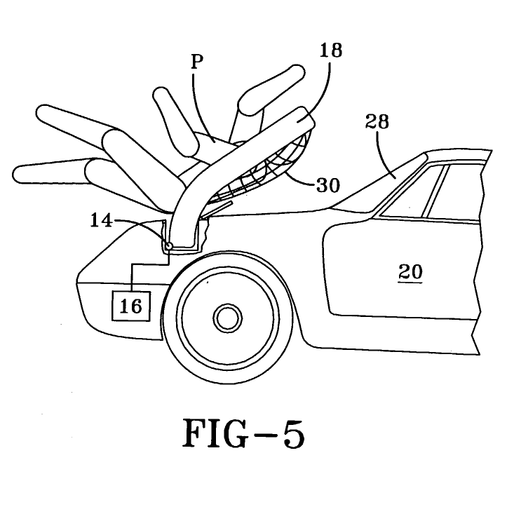

With the pedestrian protection device 18 fully deployed as shown in FIG. 4, the pedestrian protection device 18 presents a large surface to catch a pedestrian P struck by the vehicle 20. As shown in FIG. 5, the support 30 is sufficiently flexible to receive a pedestrian P and secure him from falling off of the vehicle 20. In this way, the pedestrian P is prevented from suffering further injury that may result from his collision with vehicle 20.

The aforementioned description is exemplary rather that limiting. Man y modifications and variations of the present invention are possible in light of the above teachings. The preferred embodiments of this invention have been disclosed. However, one of ordinary skill in the art would recognize that certain modifications would come within the scope of this invention. Hence, within the scope of the appended claims, the invention may be practiced otherwise than as specifically described. For this reason the following claims should be studied to determine the true scope and content of this invention.

What is claimed is:

1. A pedestrian protection device for a vehicle comprising:
an airbag inflator;
an airbag in communication with said airbag inflator, said airbag forming a frame that defines at least in part an opening; and
a support extendable across said opening.

2. The pedestrian protection device for a vehicle of claim 1 wherein said support comprises a net.

3. The pedestrian protection device for a vehicle of claim 1 wherein said airbag comprises a first member, a second member, and a third member, said first member transverse to said second member and said second member transverse to said third member.

4. The pedestrian protection device for a vehicle of claim 3 wherein said support is supportable by at least two of said first, second, and third members.

5. The pedestrian protection device for a vehicle of claim 1 including an airbag housing for receiving said airbag and said airbag inflator.

6. The pedestrian protection device for a vehicle of claim 5 wherein said airbag housing is located forward of a hood of the vehicle.

7. The pedestrian protection device for a vehicle of claim 6 wherein said opening has a width of about a width of a vehicle windshield.

8. A pedestrian protection device for a vehicle comprising:
a first inflatable member;
a second inflatable member spaced from said first inflatable member; an opening defined by said first inflatable member and said second inflatable member; and
a net extendable across said opening and supportable by said first inflatable member and said second inflatable member.

9. The pedestrian protection device for a vehicle of claim 8 wherein said net is supportable between said first inflatable member and said second inflatable member.

10. The pedestrian protection device for a vehicle of claim 8 including a third inflatable member, said third inflatable member transverse to said first inflatable member and transverse to said second inflatable member.

11. The pedestrian protection device for a vehicle of claim 10 wherein said net is supportable by at least two of said first, second, and third inflatable members.

12. The pedestrian protection device for a vehicle of claim 10 wherein said first inflatable member is in fluid communication with at least one of said second and third inflatable members.

13. The pedestrian protection device for a vehicle of claim 10 wherein said first, second and third inflatable members form a U-shape pattern.

14. A method of deploying a pedestrian protection device for a vehicle comprising the steps of:
inflating an airbag;
deploying the airbag from a location on a vehicle forward of the vehicle hood; and
extending a net across a portion of the vehicle by inflating the airbag.

15. The method of deploying the pedestrian protection device for a vehicle of claim 14 wherein the airbag extends generally perpendicular to a front portion of the vehicle.
